(19) United States
(12) Patent Application Publication
(10) Pub. No.: US 2014/0099457 A1
(43) Pub. Date: Apr. 10, 2014

(54) LIGHT-PERMEABLE HOUSING HAVING METAL LAYER AND TEXTURE OF SPECIFIC MATERIAL AND METHOD FOR MAKING THE SAME

(71) Applicant: Chao-Lang WANG, New Taipei City (TW)

(72) Inventor: Chao-Lang WANG, New Taipei City (TW)

(21) Appl. No.: 13/693,428

(22) Filed: Dec. 4, 2012

(30) Foreign Application Priority Data
Oct. 9, 2012 (TW) 101137248

(51) Int. Cl. F21V 15/01

(52) U.S. Cl. CPC F21V 15/01
USPC 428/35.8; 264/1.7; 428/34.1

(57) ABSTRACT

The present invention is to provide a light-permeable housing, which includes a metal layer evenly formed with a plurality of apertures and a bonding layer made from a mixture of a light-permeable bonding material and a solid material (such as mineral or glass powder) with a particle size smaller than the diameter of each aperture. The bonding layer is formed on the metal layer and bonds tightly thereto through the apertures to form the light-permeable housing, allow passage of light projected from a lamp inside the light-permeable housing, and thereby impart light-permeability to the light-permeable housing. Meanwhile, the portion of the metal layer that is not formed with the apertures provides a light-shielding effect that allows the overlying bonding layer to show the texture and saturated colors of the solid material, and make the light-permeable housing suitable for use in outdoor landscaping and capable of blending perfectly into natural scenery.

### FIELD OF THE INVENTION

The present invention relates to a housing, more particularly to a light-permeable housing having a metal layer and a light-permeable bonding layer, wherein the bonding layer bonds tightly to the metal layer through a plurality of apertures evenly formed on the metal layer, such that the apertures and the bonding layer allow passage of light projected from a lamp inside the light-permeable housing and thereby impart light-permeability to the light-permeable housing. Meanwhile, the portion of the metal layer that is not formed with the apertures provides a light-shielding effect that allows the overlying bonding layer to show the texture and saturated colors of a specific material or natural object contained in the bonding layer, and make the light-permeable housing suitable for use in outdoor landscaping and capable of blending perfectly into natural scenery.

### BACKGROUND OF THE INVENTION

Recently, with the advancement of craftsmanship and the improvement of living standards, one who intends to buy a certain product not only pays attention to price and durability, but also takes into account the convenience, ease of use, and decorativeness of the product. This change in market trends has driven keen players in all industries to develop newer and better products on a regular basis, with a view to meeting most consumers' needs. Take lamps frequently used in outdoor landscaping for example. A lamp of this kind is configured to project light at night so that visitors can enjoy nocturnal scenery safely in a unique tranquil ambiance created by the light. In order to prevent the lamp from being too conspicuous in an outdoor garden landscape during the day, a decorative housing mimicking the physical appearance of a rock was developed and is now commercially available for housing the lamp and blending it into natural outdoor scenery in an ingenious manner.

Generally, such a decorative housing is made by injecting an even mixture of stone powder and adhesive into a mold so that, when cured, the molded mixture resembles a rock in both shape and texture. Depending on the properties of the adhesive, the finished decorative housing may be light-permeable to different degrees, allowing the light projected from a lamp installed therein to pass through the adhesive and illuminate the surroundings diffusely and naturally. This decorative housing, though seemingly perfect, still has room for improvement in terms of design and use, as detailed below:

(1) Trade-off between light-permeability and lifelikeness: As stated above, the aforesaid decorative housing serves mainly to house a lamp; therefore, the properties of the adhesive have direct impact on the lighting level of the lamp. If the decorative housing has insufficient light-permeability, the light emitted by the lamp cannot propagate outward effectively. If, on the other hand, the decorative housing is made of an excessively light-permeable adhesive, sunlight can easily pass through the decorative housing during the day and thereby compromise the lifelikeness of the decorative housing; in other words, the decorative housing will be too transparent to light to imitate the physical appearance of a rock realistically. For designers of such decorative housings, a balance between “light-permeability” and “lifelikeness” has always been hard to find.

(2) Difficulty in lamp installation: As the decorative housing described above is formed by curing a mixture of stone powder and adhesive and does not have a structure dense enough to apply a sufficient gripping force to screws driven therein, the circuit board of the lamp may have problem being securely screwed to the inner wall of the decorative housing. More particularly, the circuit board or the lamp itself may fall off the inner wall of the decorative housing due to its own weight or an external impact. To enable secure installation of the lamp, it is often required to add a fixing structure inside the decorative housing, which nevertheless significantly increases production costs and lowers assembly efficiency.

(3) Insufficient structural strength: Aside from being an unstable structure for lamp installation, the foregoing decorative housing has extremely low structural strength. If subjected to collision during transportation or exposed to the elements for a long time, the decorative housing is very likely to peel or become damaged, ending up esthetically compromised. Hence, lack of durability is another major drawback of such decorative housings.

The issue to be addressed by the present invention is to make further improvement on the existing decorative housings so that they not only look realistic, but also are light-permeable enough to enable effective outward propagation of light from within the decorative housings.

### BRIEF SUMMARY OF THE INVENTION

In view of the design dilemma of the conventional decorative housings between “light-permeability” and “lifelikeness”, the inventor of the present invention incorporated years of practical experience into extensive research and tests and finally succeeded in developing a light-permeable housing having a metal layer and the texture of a specific material as well as a method for making the same.

It is an object of the present invention to provide a light-permeable housing having a metal layer and the texture of a specific material, wherein the light-permeable housing includes a bonding layer in addition to the metal layer. The metal layer is a planar plate made of metal (e.g., aluminum, titanium, copper, iron, lead, silver, and other metals or synthetic metals), is less than 3 mm thick, and is evenly formed with a plurality of apertures by stamping. The diameter of each aperture is 1˜2 times the thickness of the metal layer, and the spacing between each two adjacent apertures is 0.2˜2 times the diameter of each aperture. The light-permeable housing is made in the following manner. To begin with, the metal layer is kept in the planar configuration or is stamped into the desired three-dimensional shape. Then, the planar or three-dimensional metal layer is placed in between an upper mold and a lower mold. The inner walls of the upper and lower molds form a closed injection space therebetween, and the metal layer is spaced a predetermined distance from each or one of the upper and lower molds. The shape of the injection space defines the shape of the light-permeable housing. Next, a composite material is injected into the injection space. The composite material flows evenly into each aperture and eventually fills the injection space. The composite material is a mixture of an adhesive and a solid material. The adhesive is a light-permeable bonding material such as an epoxy resin or a polyester resin. The solid material, on the other hand, is silica sand, aluminum hydroxide, carbon, calcium carbonate, calcium aluminoferrite, calcium aluminosilicate, aluminum oxide, ferric oxide, silicon oxide, various metal oxides and mineral oxides, various metals and minerals, gypsum, mineral powder, or glass powder. The solid material is in the form of powder or particles, with a particle size smaller than the diameter of each aperture and small enough to pass through a mesh with 200 openings per square centimeter. The mixing ratio of the adhesive to the solid material by weight is 1 to 0.8182˜1.8571 (i.e., the solid material making up 45%˜65% of the weight of the composite material). The composite material is completely cured after a predetermined amount of time. As a result, the bonding layer is formed on the metal layer and bonds tightly thereto through the apertures to form the light-permeable housing of the present invention. The apertures and the light-permeable bonding material allow passage of light projected from a lamp inside the light-permeable housing and thereby impart light-permeability to the light-permeable housing. Meanwhile, the portion of the metal layer that is not formed with the apertures provides a light-shielding effect that allows the overlying bonding layer to show the texture and saturated colors of a specific material or natural object (e.g., a rock, a dry piece of wood, a small mountain, and so on). Hence, the light-permeable housing is suitable for use in outdoor landscaping and can blend perfectly into natural scenery.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a sectional view of a light-permeable housing according to the present invention;

FIG. 2 is the flowchart of a method for making a light-permeable housing according to the present invention;

FIG. 3A shows a detail of the method illustrated in FIG. 2;

FIG. 3B shows another detail of the method illustrated in FIG. 2; and

FIG. 3C shows still another detail of the method illustrated in FIG. 2.

### DETAILED DESCRIPTION OF THE INVENTION

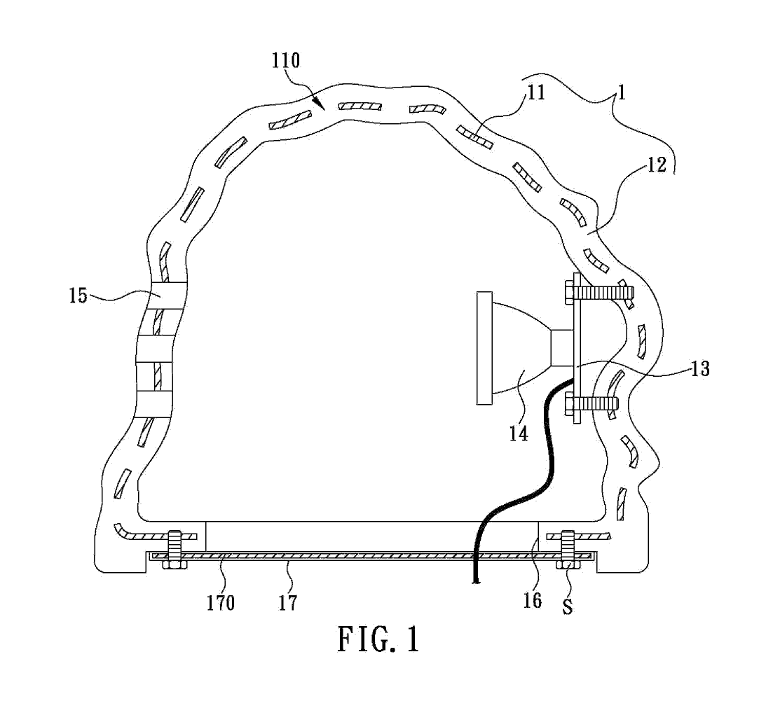

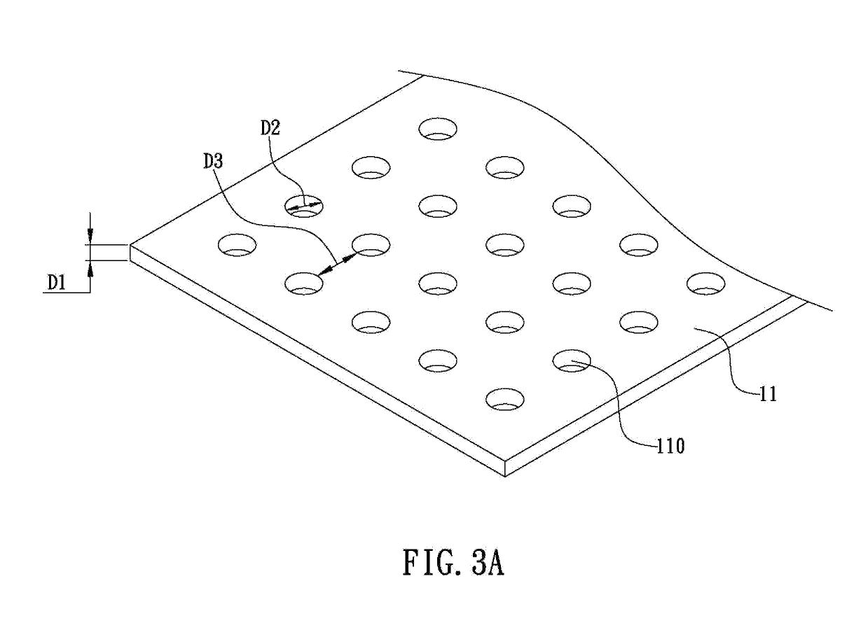

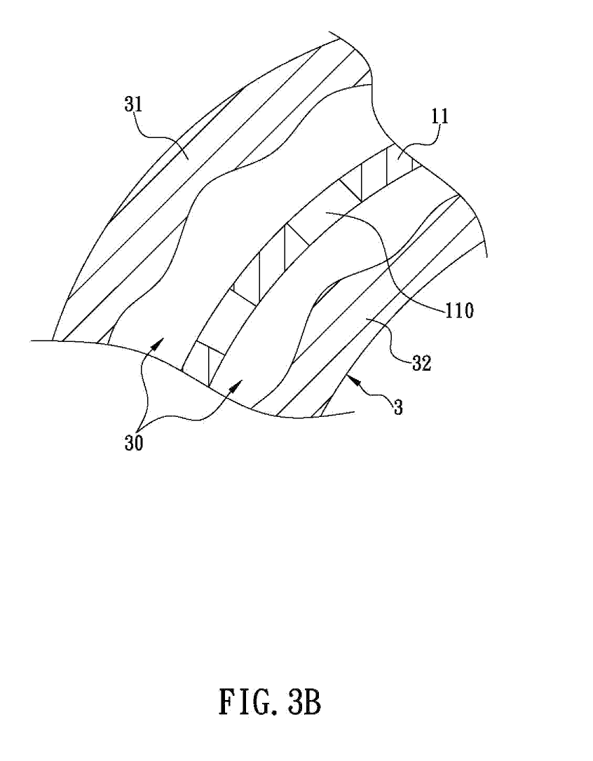

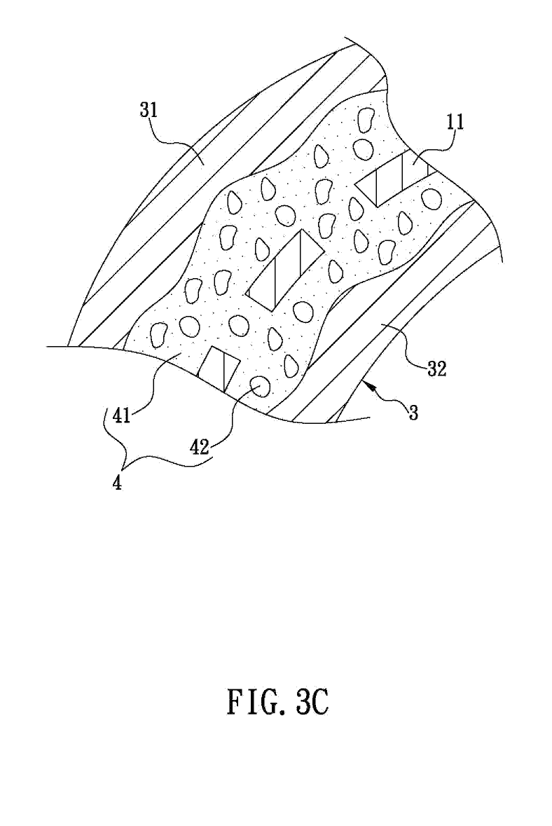

The present invention discloses a light-permeable housing having a metal layer and the texture of a specific material and a method for making the light-permeable housing. Referring to FIG. 1 for the first preferred embodiment of the present invention, the light-permeable housing 1 includes a metal layer 11 and a bonding layer 12. The metal layer 11 is composed of a planar plate made of metal. The metal layer 11 may be stamped into a three-dimensional shape in advance or kept in the planar configuration. The metal layer 11 is formed with a plurality of apertures 110. In the first preferred embodiment of the present invention, referring to FIG. 3A, the thickness D1 of the metal layer 11 is less than 3 mm, the diameter D2 of each aperture 110 is 1˜2 times the thickness Dl of the metal layer 11, and the spacing D3 between each two adjacent apertures 110 is 0.2˜2 times the diameter D2 of each aperture 110.

Referring back to FIG. 1, the bonding layer 12 is composed of a composite material formed by mixing an adhesive and a solid material. The adhesive is a light-permeable bonding material. The solid material may have, as its ingredients, powder or particles of various metals, metal oxides, minerals, or mineral oxides, with a particle size smaller than the diameter of each aperture 110. The composite material flows evenly into the apertures 110 and, once completely cured, forms the bonding layer 12, which bonds securely to the metal layer 11. Thus, the light-permeable housing 1 has sufficient light-permeability attributable to the apertures 110 and the light-permeable bonding material. At the same time, the portion of the metal layer 11 that is not formed with the apertures 110 provides a light-shielding effect, keeping sunlight from entering the light-permeable housing 1. Now that sunlight is prevented from entering, let alone being reflected within, the light-permeable housing 1, the lifelikeness of the light-permeable housing 1 will not be impaired. Instead, the bonding layer 12 is allowed to show on its exterior the texture, shape, and true saturated colors of a specific material or natural object (e.g., a rock, the surface of a mountain, a tree trunk, and so on) as determined by the composition of the solid material, giving the light-permeable housing 1 a natural-looking decorative effect.

Referring again to FIG. 1, in addition to allowing passage of light, the apertures 110 evenly arranged on the metal layer 11 serve as an ideal structure for screwing. Therefore, by means of screws S, a circuit board 13 can be secured in the light-permeable housing 1 at a position corresponding to the apertures 110. The structural strength of the metal layer 11 ensures that the circuit board 13 and the lamp 14 mounted thereon will be firmly positioned. Moreover, the toughness of the metal layer 11 and the elasticity of the bonding layer 12 result in a strong gripping force on the screws S that prevents the screws S from getting loose. The elasticity of the bonding layer 12 and the toughness of the metal layer 11 also provide the light-permeable housing 1 with high structural strength and hardness that protect the light-permeable housing 1 from damage which may otherwise result from collision. As such, the light-permeable housing 1 is perfect for use as a lampshade in outdoor landscaping.

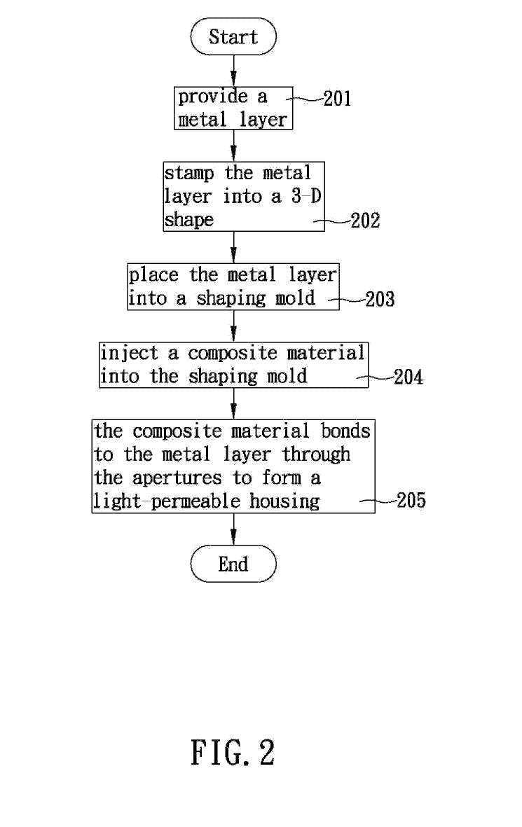

A detailed description of how the present invention can be implemented is given below with reference to the flowchart in FIG. 2 in conjunction with FIGS. 3A˜3C:

(201) A metal layer 11 as shown in FIG. 3A is provided. The metal layer 11 is composed of a planar plate made of aluminum, titanium, copper, iron, lead, silver, or other metals or synthetic metals, and is evenly formed with a plurality of apertures 110 by stamping.

(202) By a stamping process, the metal layer 11 is stamped into a three-dimensional shape.

(203) Referring to FIG. 3B, the three-dimensional metal layer 11 is placed into a shaping mold 3 which includes an upper mold 31 and a lower mold 32. The upper and lower molds 31 and 32 form a closed injection space 30 therebetween. The metal layer 11 is spaced from each of the upper and lower molds 31 and 32 by a predetermined distance such that the injection space 30 defines the configuration of the light-permeable housing.

(204) Referring to FIGS. 3C and 3B, a composite material 4 is injected into the injection space 30. The composite material 4 is formed by mixing an adhesive 41 and a solid material 42 evenly. In this embodiment, the adhesive 41 is a light-permeable bonding material such as an epoxy resin or a polyester resin, and the solid material 42, which is powdery or particulate in form, may be silica sand, aluminum hydroxide, carbon, calcium carbonate, calcium aluminoferrite, calcium aluminosilicate, aluminum oxide, ferric oxide, silicon oxide, various metal oxides and mineral oxides, various metals and minerals, gypsum, mineral powder, or glass powder. The composite material 4 flows evenly into the apertures 110 and fills up the injection space 30.

(205) As shown in FIGS. 1 and 3C, once the composite material 4 is completely cured, which takes a predetermined amount of time, the composite material 4 forms a bonding layer 12 on the metal layer 11. The composite material 4 in this state bonds tightly to the metal layer 11 through the apertures 110 such that a single unit, i.e., the light-permeable housing 1, is formed.

After repeated experiments, the inventor has found that the light-permeable housing 1 can have the ideal rock-like appearance and light-permeability if, in addition to the thickness D1 of the metal layer 11 being less than 3 mm, the diameter D2 of each aperture 110 being 1˜2 times the thickness Dl of the metal layer 11, and the spacing D3 between each two adjacent apertures 110 being 0.2˜2 times the diameter D2 of each aperture 110, the solid material 42 occupies 45%˜65% of the weight of the composite material 4, meaning the mixing ratio by weight of the adhesive 41 to the solid material 42 is 1 to 0.8182˜1.8571. Apart from that, the particle size of the solid material 42 must be small enough to pass through a mesh having 200 openings per square centimeter. This allows the composite material 4 to bond tightly to the metal layer 11 through the apertures 110.

It should be pointed out that, while the rock-like shape and texture of the light-permeable housing 1 in the foregoing embodiment and the accompanying drawings are achieved by the solid material 42 in the bonding layer 12, it is feasible in another preferred embodiment of the present invention to vary the ingredients and composition of the composite material or change the configuration of the shaping mold 3 in order to shape the light-permeable housing 1 into a small mountain, a piece of dry wood, a root of a tree, or other natural objects and provide the light-permeable housing 1 with the corresponding texture. Besides, the metal layer 11 in the foregoing embodiment is stamped into a three-dimensional shape before placement into the shaping mold 3; however, depending on the manufacturer's design or the desired shape of the light-permeable housing 1, it is also feasible in another preferred embodiment of the present invention to keep the metal layer 11 in its planar configuration and place the planar metal layer 11 into a corresponding shaping mold 3 for subsequent treatment. The resulting light-permeable housing 1 will be a planar light-permeable plate with the desired texture.

Referring back to FIG. 1, the manufacturer may further drill a plurality of holes 15 through the finished light-permeable housing 1 at predetermined positions so that, once the lamp 14 is installed in the light-permeable housing 1, the light emitted by the lamp 14 can project outward not only through the apertures 110 and the bonding layer 12, but also through the holes 15, which communicate with certain apertures 110, thus creating a different light-and-shadow effect. Moreover, in the first preferred embodiment of the present invention, the bottom of the light-permeable housing 1 is provided with an assembly hole 16 in communication with the interior of the light-permeable housing 1 so that the lamp 14 can be installed into the light-permeable housing 1 via the assembly hole 16. In addition, the assembly hole 16 may be fitted with a sealing plate 17. The sealing plate 17 includes a metal plate 170 therein and serves to seal the assembly hole 16 after installation of the lamp 14. In another preferred embodiment of the present invention, the light-permeable housing 1 is further provided therein with at least one speaker, whose audio signals can be transmitted outward through the apertures 110 and the holes 15. Thus, the at least one speaker is cleverly disguised as a rock in the same way as the lamp 14 and suitable for use in outdoor landscaping.

Lastly, it should be pointed out that the metal layer 11 is not necessarily spaced from each of the upper and lower molds 31 and 32 by a predetermined distance as shown in FIG. 3B. In a different preferred embodiment of the present invention, the metal layer 11 may be spaced from only one of the upper and lower molds 31 and 32, depending on the manufacturer's design considerations and requirements. For instance, the metal layer 11 may have one side lying against the lower mold 32 and the other side spaced from the upper mold 31. In that case, referring to FIG. 1, the side of the metal layer 11 that lies against the lower mold 32 will be the side facing the interior of the light-permeable housing 1. And even though the bonding layer 12 does not cover this side of the metal layer 11 completely, the bonding layer 12 can still bond tightly to the metal layer 11 through the apertures 110, so as for the light-permeable housing 1 to resemble a rock or other natural objects or have any specific shape.

While the invention herein disclosed has been described by means of specific embodiments, numerous modifications and variations could be made thereto by those skilled in the art without departing from the scope of the invention set forth in the claims.

What is claimed is:

1. A method for making a light-permeable housing having a metal layer and a texture of a specific material, comprising the steps of:
providing the metal layer, wherein the metal layer is a planar plate made of metal and is formed with a plurality of apertures by stamping;
placing the metal layer in between an upper mold and a lower mold, wherein an inner wall of the upper mold and an inner wall of the lower mold form a closed injection space therebetween, the metal layer is spaced from each or one of the upper mold and the lower mold by a predetermined distance, and the injection space has a configuration defining a configuration of the light-permeable housing;
injecting a composite material into the injection space, wherein the composite material is formed by mixing an adhesive and a solid material, the adhesive is a light-permeable bonding material, the solid material is in form of powder or particles and has a particle size smaller than a diameter of each said aperture, and the composite material is able to flow into the apertures and fill the injection space; and
curing the composite material completely such that the composite material forms a bonding layer on the metal layer, and the bonding layer bonds tightly to the metal layer through the apertures to form the light-permeable housing.

2. The method of claim 1, further comprising the step, performed before placing the metal layer in between the upper mold and the lower mold, of stamping the metal layer into a three-dimensional shape.

3. The method of claim 2, further comprising the step, performed after the light-permeable housing is formed, of drilling at least a hole through the light-permeable housing such that the at least a hole is in communication with at least a said aperture.

4. A light-permeable housing having a metal layer and a texture of a specific material, comprising:
the metal layer formed with a plurality of apertures; and
a bonding layer composed of a composite material, wherein the composite material is formed by mixing an adhesive and a solid material, the adhesive is a light-permeable bonding material, the solid material is in form of powder or particles and has a particle size smaller than a diameter of each said aperture, and the composite material is able to flow into the apertures and, once completely cured, bond to the metal layer to form the light-permeable housing.

5. The light-permeable housing of claim 4, wherein the metal layer is a planar plate made of metal, and the metal layer is stamped into a three-dimensional shape.

6. The light-permeable housing of claim 5, wherein the diameter of each said aperture is 1˜2 times a thickness of the metal layer, and a spacing between each two adjacent said apertures is 0.2˜2 times the diameter of each said aperture.

7. The light-permeable housing of claim 6, wherein the thickness of the metal layer is less than 3 mm.

8. The light-permeable housing of claim 7, wherein a ratio by weight of the adhesive to the solid material is 1 to 0.8182˜1.8571.

9. The light-permeable housing of claim 8, wherein the adhesive is an epoxy resin or a polyester resin.

10. The light-permeable housing of claim 9, wherein the solid material is metal particles, metal oxide particles, mineral particles, or mineral oxide particles.

11. The light-permeable housing of claim 10, wherein the particle size of the solid material is small enough to pass through a mesh having 200 openings per square centimeter.

12. The light-permeable housing of claim 11, wherein the solid material is silica sand, aluminum hydroxide, carbon, calcium carbonate, calcium aluminoferrite, calcium aluminosilicate, aluminum oxide, ferric oxide, silicon oxide, gypsum, stone powder, or glass powder.

13. The light-permeable housing of claim 12, wherein the metal layer is made of aluminum, titanium, copper, iron, lead, silver, or an alloy thereof.
